(19) United States
(12) Patent Application Publication
(10) Pub. No.: US 2014/0314406 A1
(43) Pub. Date: Oct. 23, 2014

(54) Systems and Methods for Temperature Insensitive Photonic Transmission

(71) Applicant: Rambus Inc., Sunnyvale, CA (US)

(72) Inventors: Jared L. Zerbe, Woodside, CA (US); Dinesh Dilip Patil, Sunnyvale, CA (US)

(21) Appl. No.: 14/357,386

(22) PCT Filed: Nov. 30, 2012
(86) PCT No.: PCT/US12/67401

§ 371 Date: May 9, 2014

Related U.S. Application Data
(60) Provisional application No. 61/568,800, filed on Dec. 9, 2011.

(51) Int. Cl. H04J 14/02; H04B 10/079

(52) U.S. Cl. CPC H04J 14/0221; H04B 10/07955
USPC 398/38; 250/208.2

(57) ABSTRACT

A photonic communication system communicates M signals over a waveguide by modulating M wavelengths of light. N photonic rings at a receiver, where N is greater than M, are used to demodulate the M wavelengths. The modulated frequencies and resonant wavelengths of the receive rings are allowed to drift relative to one another. The number of receive rings is greater than the number of modulated frequency, and the number and optical characteristics of the receive rings are selected such that a subset of the receive rings effectively demodulates over the operational frequency range of the incoming light. The system tracks relative drift between the modulated wavelengths and the resonant wavelengths of the receiving rings and automatically selects the correct modulated signal or signals from among the receiving rings. The free spectral ranges and optical lengths of the receive rings are selected to reduce or minimize the number of receive rings required to span the optical bandwidth of the modulated light.

### TECHNICAL FIELD

The subject matter presented herein relates generally methods and systems for conveying and receiving data through optical signals.

### BACKGROUND

Light propagates through optical fibers with little attenuation, which allows for high bandwidth communication over distances that are long relative to electrical cables. A given fiber can carry many independent communication channels, each using a different wavelength of light, for greatly improved communication bandwidth for the fiber. (A single-mode fiber is typically used.) Combining data transmission through different wavelengths into a single channel, and subsequently separating them to recover the disparate information, is commonly referred to as wavelength-division multiplexing (WDM). A subset of WDM, commonly referred to as dense WDM (DWDM) combines data from, in some cases, seventy-five or more channels using respective wavelengths into a single fiber.

Information is conveyed over a given optical channel by modulating the phase or intensity of light at a given wavelength and transmitting the resultant modulated beam. The wavelength is subsequently demodulated at a receiver to recover the information. Among the known modulation and demodulation schemes, a technology variously referred to as “optical ring resonators” or “photonic rings” are one method of supporting high-performance WDM systems. A photonic ring includes a closed-loop waveguide adjacent to at least one other waveguide. The closed-loop waveguide has optical properties that cause it to exhibit resonance at particular wavelengths. When light of a resonant wavelength passes through the adjacent waveguide, typically by means of an integer number of trips around the ring, that light is coupled to the loop where it builds in intensity via constructive interference. The resulting intense light may be dissipated into the substrate to create a “notch” at that particular wavelength in the passing beam in the adjacent waveguide. The extent and/or location of this notch can be manipulated to modulate that beam, or may be sensed to recover a modulated signal. Wavelengths other than those that are resonant tend to pass through the adjacent waveguide directly with minimal loss.

Different photonic rings can be placed in series adjacent to one waveguide to pick off different signal wavelengths, and thus distinguish among multiple communication channels in the same waveguide. However, the optical properties of photonic rings can be highly temperature dependent. This is particularly true of silicon photonic devices. Uncorrected, the resonant wavelengths of a photonic ring tuned to recover a signal modulated at a given carrier wavelength will therefore drift away from the carrier wavelength with temperature variation until it cannot any longer recover the modulated signal. Efforts to control the temperatures of photonic rings—and thus limit the undesirable drift—have met with limited success, primarily due to the power inefficiency of thermal heating as the significant reasonable control source.

### BRIEF DESCRIPTION OF THE FIGURES

FIG. 1 depicts a photonic communication system 100 that ameliorates the problem of temperature-induced drift in accordance with one embodiment.

FIG. 2 (prior art) depicts photonic rings 200 and 205 adjacent a waveguide 210 that serves as communication medium.

FIG. 3 (prior art) is a waveform diagram 300 illustrating how light of different wavelengths constructively or destructively interferes in a photonic ring of optical length L.

FIG. 4 (prior art) is waveform-response diagram 400 illustrating hypothetical wavelength responses WR[1:2] for respective transmit resonators Tx[1:2] of FIG. 1.

FIGS. 5A to 5D illustrate how one embodiment of a two-channel optical system can employ four resonators to accommodate drift at the transmitter, the receiver, or both.

FIG. 6 illustrates an embodiment that includes two transmit photonic rings Tx1 and Tx2 (M=2) and eight receive resonators Rx[1:8] (N=8).

The figures are illustrations by way of example, and not by way of limitation. Like reference numerals in the figures refer to similar elements.

### DETAILED DESCRIPTION

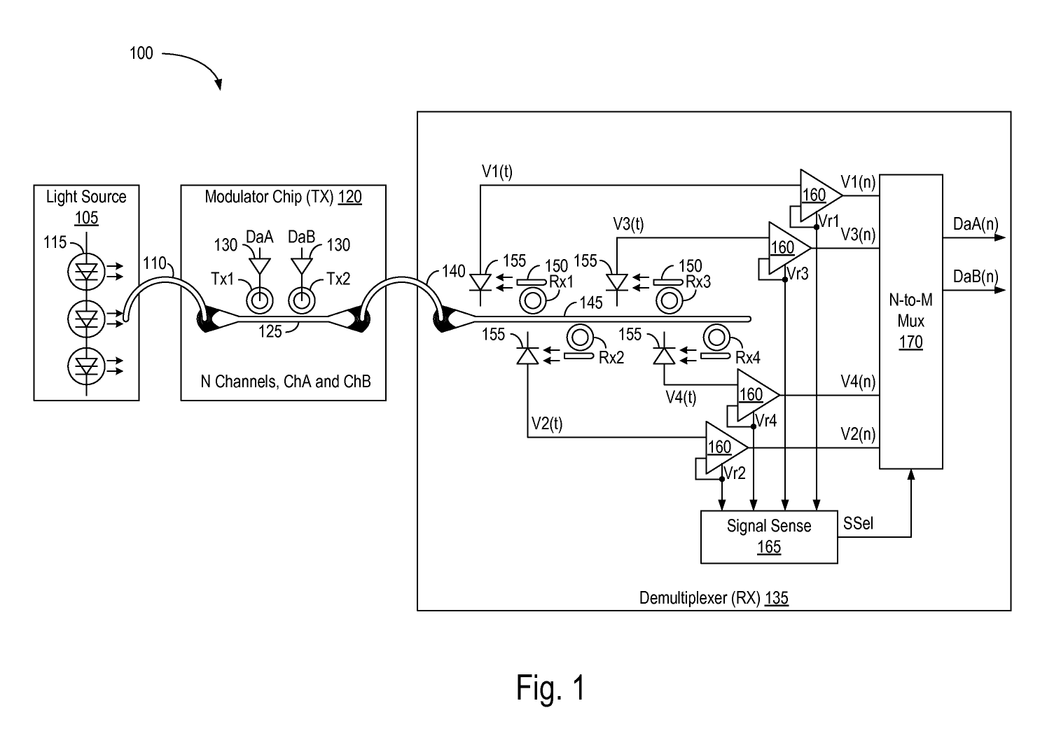

FIG. 1 depicts a photonic communication system 100 that ameliorates the problem of temperature-induced drift in accordance with one embodiment. Silicon photonic rings are used to modulate and demodulate optical signals. Rather than or in addition to stabilizing the temperature of the photonic rings to avoid deleterious drifting of their resonant wavelengths, the transmitter modulated wavelengths are allowed to drift relative to the resonant wavelengths of the receiving rings, and vice versa. The number of receive rings is greater than the number of modulated wavelengths, and the individual characteristics of the receive rings are selected such that a subset of the receive rings effectively demodulates over the operational frequency range of the incoming light. System 100 tracks drift between receive rings and automatically selects the correct modulated signal or signals from among the array of spaced receiving rings. As is well known, wavelength is the reciprocal of frequency, and the terms are often used interchangeably.

System 100 includes a light source 105 that delivers light of a desired bandwidth over an optical waveguide (e.g., an optical fiber) 110. Light source 105 includes one or more laser diodes 115 selected to provide a desired intensity and bandwidth of light. This light is conveyed through a transmit/modulator chip 120 via an integrated waveguide 125. Modulator chip 120 includes drivers 130 and associated photonic rings Tx1 and Tx2 that modulate respective frequencies of the light passing through waveguide 125 to provide M communication channels ChA and ChB (M=2 in this example). The resultant M-channel modulated beam is then conveyed to a demultiplexing receiver 135 via a waveguide 140, such as an optical fiber. Light source 105 and modulator chip 120 are well understood by those of skill in the art, so a detailed discussion is omitted for brevity.

Demultiplexer 135, an optical receiver, includes an input waveguide 145 to convey the incoming light from modulator chip 120. That light has an optical bandwidth that encompasses a range of wavelengths, some of which are modulated to convey information via two or more channels, or two channels as shown for simplicity in FIG. 1, channels ChA and ChB. Demultiplexer 135 additionally includes N=4 four optical resonators Rx[1:4], each of which includes a photonic ring having a respective optical length and consequently resonates at a respective set of wavelengths. Each resonator is adjacent to both input waveguide 145 and a respective electro-optical sensor that combines an output waveguide 150 and a photodetector 155. In the example shown in FIG. 1 the four electro-optical sensors produce respective voltage signals V[1:4](t), the amplitudes of which are measures of the light intensities from the resonant frequencies associated with the respective optical resonators. The amplitude of voltage V1(t), for example, is a measure of the intensity of light from resonator Rx1, and therefore of the specific wavelengths within the incoming modulated light signal that resonate within resonator Rx1.

Each of voltage signals V[1:4](t) is conveyed to a respective sampler 160. The samplers derive voltage references Vr[1:4] from respective signals V[1:4](t). In an embodiment in which the voltage signals are DC-balanced, for example, each sampler 160 averages the incoming signal to derive its reference signal. Samplers 160 then periodically compare the incoming signal against the respective reference voltage to recover digital signals V[1:4](n). The samples are taken on edges of a timing reference, such as a clock signal (not shown), that can be derived from the incoming signals or source elsewhere. Samplers 160 are one-bit analog-to-digital converters in this embodiment, but can provide increased resolution in other examples. Samplers and the derivation of reference voltages are well known to those of skill in the art.

Modulator chip 120 only modulates two wavelengths, or two sets of wavelengths, in this example, yet demultiplexer 135 includes four optical resonators. Signal-sense circuitry 165 senses which two of the four analog signals V[4:1](t) provide the highest fidelity signal amplitude. Circuitry 165 then issues select signals SSel to an N:M multiplexer 170 that conveys the sampled versions of the two relatively high-amplitude signals to output nodes DaA(n) and DaB(n). If samplers 160 associated with signals V1(t) and V3(t) produce the highest reference voltages, for example, sense circuitry 165 causes multiplexer 170 is connect nodes V1(n) and V3(n) to output nodes DaA(n) and DaB(n). The resonators that produce relatively low-amplitude output signals (e.g., V2(n) and V4(n)) are ignored in this example. Note that “signal” in this context includes the ability of the receiver to receive distinctly different “1” and “0” amplitudes with a high signal-to-noise ratio and not a single distinct signal level. Samplers 160, sense circuitry 165, and multiplexer 170 thus collectively form an N-to-M circuit that converts N electrical signals from the N electro-optical sensors to M electronic signals DaA(n) and DaB(n) that have a high quality signal to noise ratio.

Temperature changes at modulator chip 120 can cause the transmit modulated wavelengths to drift. Likewise, temperature changes at demultiplexer 135 can cause the resonant frequencies of resonators Rx[1:4] to drift. Because of the relatively high thermal conductivity of silicon, neighboring resonators (e.g., rings on the same receiver or IC) will tend to experience substantially the same environmental changes, and will consequently drift together. Conversely, circuits used at different ends of the communication channels may experience substantially different power and temperature variations, and may consequently exhibit substantially different resonant frequency fluctuations. The optimum selection of resonators Rx[1:4] for demodulating a given modulated wavelength can therefore shift from one to another. Such a change in preference is indicated when the reference voltage developed by one of samplers 160 exceeds that of another. Assume, for example, that signal V1(n) is selected for output to node DaA(n), and signal V2(n) is not. Further assume that the temperature of demultiplexer 135 is rising, in which case one can expect the resonance of resonator Rx1 to drift away from the modulated wavelength, and that of resonator Rx2 to drift toward the modulated frequency. Should reference voltage Vr1 fall below voltage Vr2, indicating that signal Vr2 is likely a better representation of signal DaA on channel ChA, then sense circuitry 165 instructs multiplexer 170 to connect signal V2(n) to node DaA(n) in lieu of signal V1(n). Demultiplexer 135 thus manages frequency fluctuations by following the resultant drift rather than attempting to control it through thermal management. Other embodiments supplement the accommodation of drift with some form of thermal isolation and/or control on either or both sides of the communication channels.

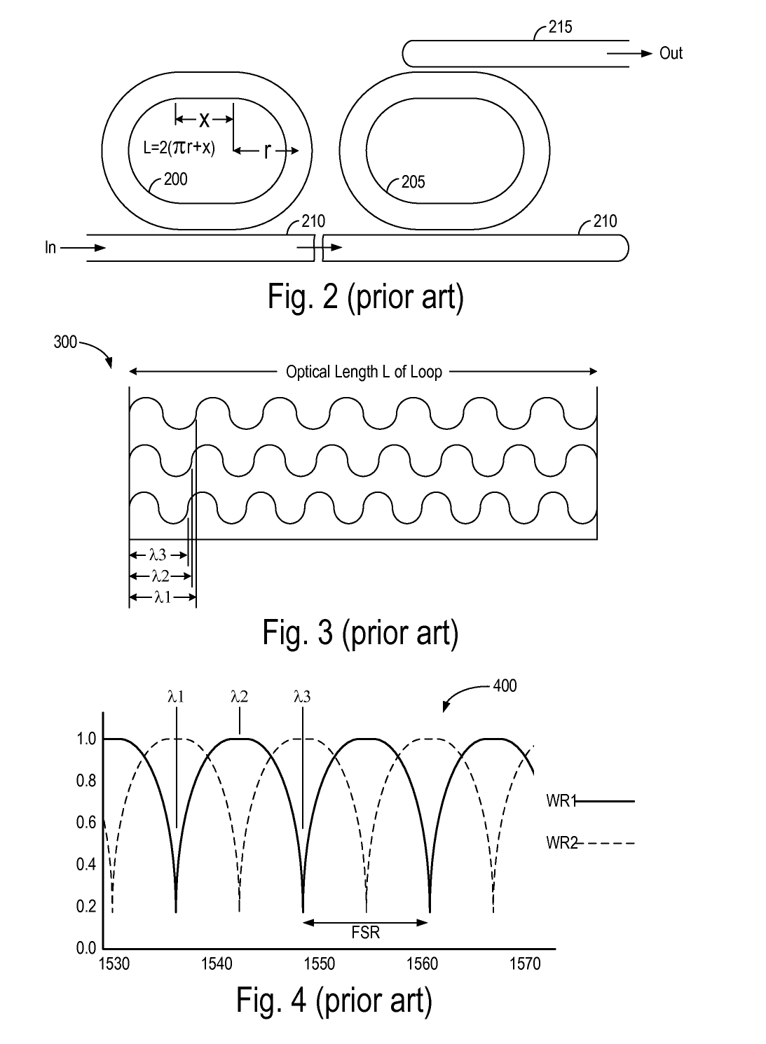

Optical resonators are familiar to those of skill in the art. It may nevertheless be helpful to illustrate why a given optical resonator resonates at a set of wavelengths. FIGS. 2-4 and the related discussion provide a high-level description of the operation of some types of optical resonators.

FIG. 2 (prior art) depicts photonic rings 200 and 205 adjacent a waveguide 210 that serves as communication medium. Light entering input waveguide 210 exhibits an optical bandwidth, or a range of wavelengths. Some of that light couples into adjacent ring 200 via the small space separating the two waveguides via a process is known as evanescent coupling. For some of the passing wavelengths, the optical length L of ring 200 is an integer multiple of the wavelength. These wavelengths will couple more efficiently into ring 200, and thus be removed from waveguide 210. The absorbed light travels around ring 200 and is eventually scattered into the surrounding material. Ring 200 thus interferes with specific frequencies of the light, creating relatively dim notches in the light that passes by ring 200 on its way toward the receive resonator, ring 205. Ring 200 has a very narrow bandwidth, so many similar rings can be placed adjacent waveguide 210 to modulate different wavelengths in support of separate communication channels over a single waveguide or fiber.

Ring 205 works in essentially the same way as ring 200. Rather than simply attenuating light at the resonant frequencies of ring 205, however, an output waveguide 215 is added to couple light from ring 205 to a photodetector (not shown). Ring 205 absorbs light of its resonant frequency. The absorbed light is evanescently coupled to an output waveguide 215 and the intensity of this coupled wavelength is then converted to an electrical signal via a photodetector.

If rings 200 and 205 are of the same optical length, the relatively dim notches in the light conveyed past ring 200 will be at the resonant frequencies of ring 205. As a consequence, the intensity from output waveguide 215 will be relatively low. Misaligning the notches, as by modulating the optical length at the ring 200, allows light of the resonant wavelength of ring 205 to pass by ring 200. Light of the resonant wavelength of ring 205 will therefore pass by ring 205, leading to a relatively high intensity from output waveguide 215. In this manner ring 200 can function as a transmitter, and ring 205 and waveguide 215 can function as a receiver that can receive either low or high intensity of a given light wavelength depending on the modulation of the transmit channel.

Rings 200 and 205 are essentially elliptical in this example, but other shapes can be used. The length L of ring 200 is 2(πr+x), where r is the radius of the curves and x is the length of the straight side portions. Length L also depends upon the optical properties of the waveguide, as is well understood by those of skill in the art. Resonators that include one or more straight portions are sometimes referred to as photonic “rings,” so the term “ring” does not imply a circular shape in this context.

FIG. 3 (prior art) is a waveform diagram 300 illustrating how light of different wavelengths constructively or destructively interferes in a photonic ring of optical length L. The uppermost waveform is of wavelength λ1. The optical length L is 7λ1, so light of this frequency will constructively interfere in ring 200. This frequency will consequently be drawn away from the passing light, leaving a relatively dim notch in the frequency band. The middle waveform is of a wavelength λ2, and optical length L is 6.5λ1. Light of this second frequency will destructively interfere, and will thus poorly couple to ring 200, leaving the light at that wavelength to carry on toward receive ring 205. Finally, the lowermost waveform is of wavelength λ3, and the optical length L is 8λ3. Light of this frequency will thus constructively interfere in the loop, leaving another relatively dim notch.

FIG. 4 (prior art) is waveform-response diagram 400 illustrating hypothetical wavelength responses WR[1:2] for respective transmit resonators Tx[1:2] of FIG. 1. (Wavelength T is the reciprocal of frequency F, so diagram 400 may also be referred to as a frequency-response diagram.) The X axis represents wavelengths in nanometers and the Y axis output intensity on a normalized scale. The relatively bold waveform for response WR1 corresponds to the example of FIG. 3, and symbolizes the light spectrum conveyed to receive ring 205 of FIG. 2. The waveforms of wavelengths λ1 and λ3 resonate with ring 200, and consequently produce intensity minima, while wavelength λ2 does not resonate with ring 200 and so is conveyed past ring 200 as a relative maximum. The relative minima repeat for each wavelength within the bandwidth of the light that resonates with ring 200.

The separation between the resonant wavelengths of the optical resonator is termed the free spectral range (FSR). Stated mathematically, the FSR for a given photonic ring of optical length L is:

FSR=L/n(n+1) (1)

where n is the integer number of wavelengths that divide evenly into length L. Assume, for example, that an incoming signal has an optical bandwidth that encompasses from 1,530 to 1,570 nanometers is input to a photonic ring in which length L is 185 micrometers. One minima in the range from 1,530 to 1,550 nanometers would occur when n is 119, at 1,555 nanometers, and another when n is 120, at 1,542 nanometers. The FSR in that example would be 1,555−1,542 nanometers=13 nanometers. The optical bandwidth includes all the wavelengths over which an optical communication signal can be expected to communicate information, and should be of sufficient breadth to accommodate any anticipated drift between the transmitter and receiver.

In the example of FIG. 1, each transmit ring Tx[1:2] has a different length L, and so passes light with minima at different wavelengths. The wavelength responses WR1 and WR2 have evenly spaced minima, or peaks, though this in not necessarily so. Responses WR1 and WR2 have about the same FSRs, and generally drift together with temperature, with each minima moving in tandem along the X axis. At the receive side, each of optical resonators Rx[1:4] has a different optical length L, so the resonators resonate at different wavelengths. The FSRs of the receive resonators are the same as those of the transmit rings, and are essentially equal over the frequency range of the incoming light. Further, as detailed in connection with later figures, the FSRs of resonators Rx[1:4] are offset from one another such that their minima effectively span the frequency range of the incoming light.

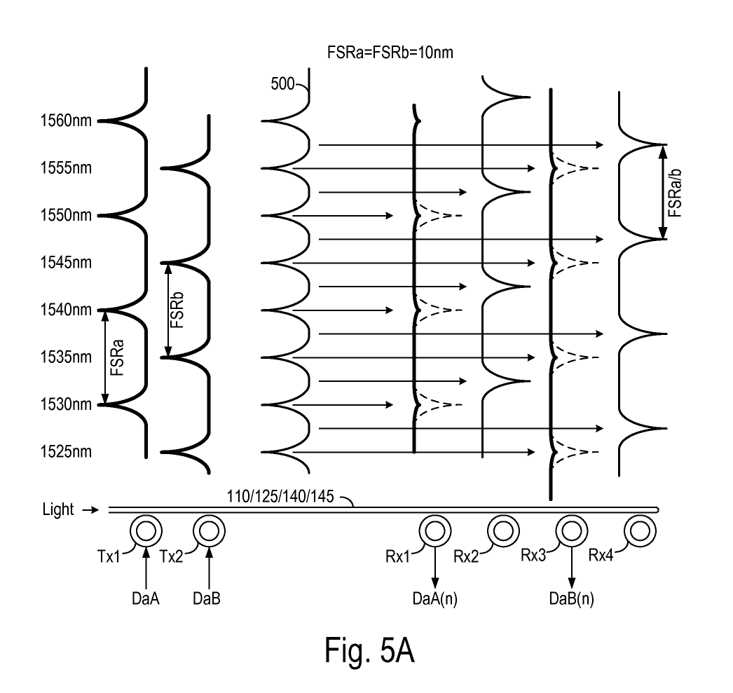

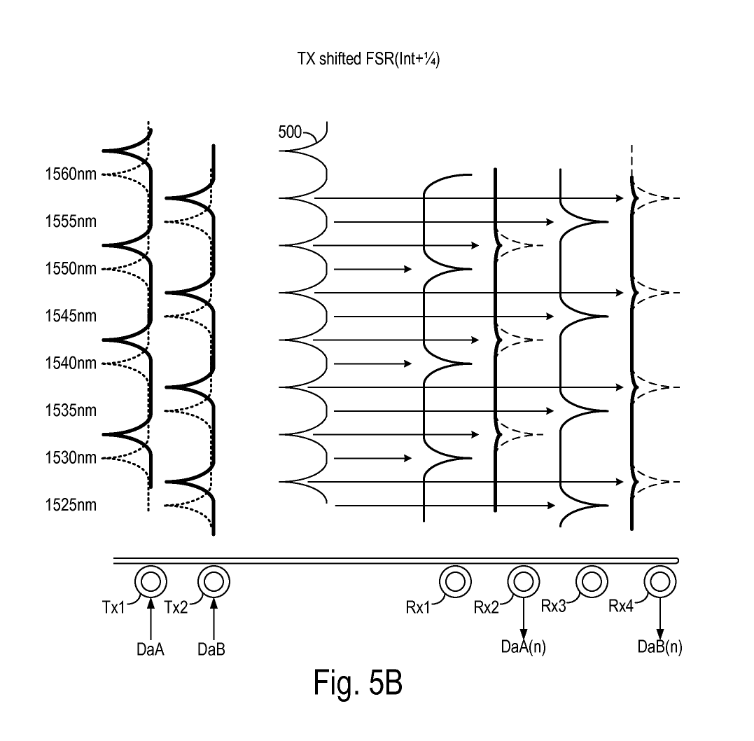

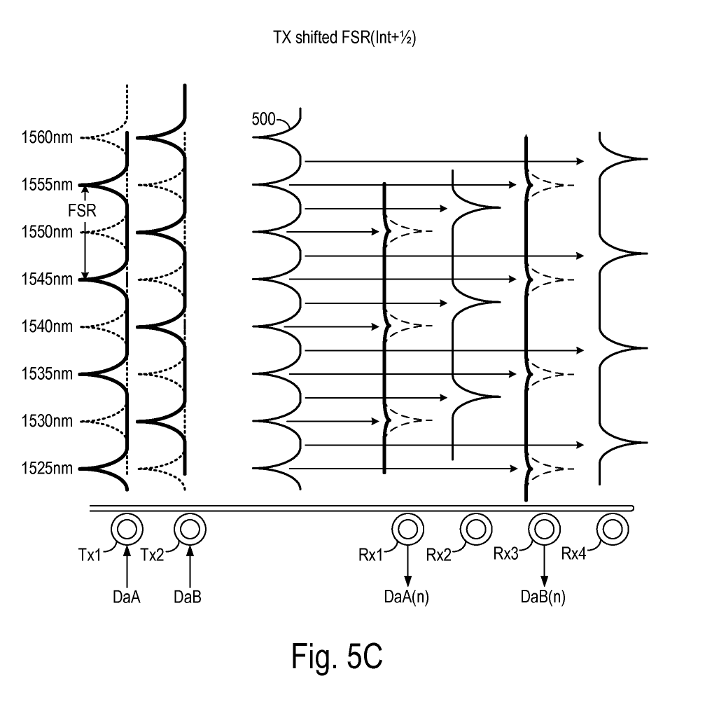

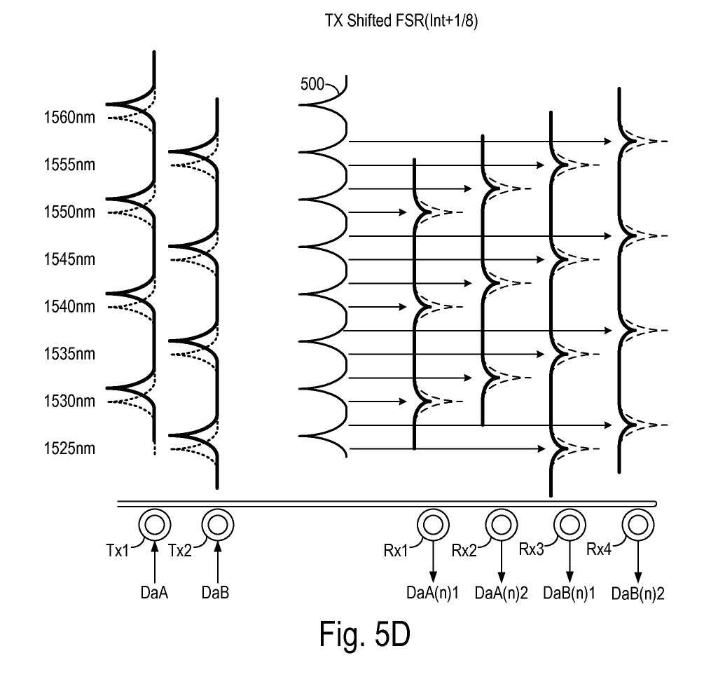

FIGS. 5A to 5D illustrate how one embodiment of a two-channel optical system can employ four resonators to accommodate drift at the transmitter, the receiver, or both. These figures and the accompanying description reference aspects of system 100 of FIG. 1, with like-identified elements being the same or similar. The example assumes frequency drift at the transmitter, but system 100 equally adapts to drift at the receiver, at both the transmitter and receiver, or a relative drift between both transmit and receive sides of the system. System 100 also accommodates resonance offsets due to other sources, such as supply-voltage fluctuations and process variations.

With reference to FIG. 5A, the two traces at the left represent the frequency responses of transmit photonic rings Tx1 and Tx2, respectively. A trace 500 represents the combined frequency response for light passing by rings Tx1 and Tx2 in series in the path of waveguides 125 (FIG. 1), which is conveyed to the receive resonators. The peaks of trace 500 represent intensity minima for the light in the waveguide. These minima occur at the resonant wavelengths of both transmit rings Tx1 and Tx2. The optical length of rings Tx1 and Tx2 can be changed by actively controlling the carrier density, and thus the refractive index of the waveguide material (e.g., silicon). Such control can be via a respective information signals DaA and DaB to modulate the light entering waveguides 110/125/140/145 from the light source, and thus to convey information from signals DaA and DaB to resonators Rx[1:4].

The optical lengths of rings Tx1 and Tx2 increase from left to right in this example. Their responses have substantially the same FSRs (FSRa≈FSRb) within the bandwidth of the incoming light, and the FSRs are offset by about half the common FSR in this example. The bandwidth of the incoming light is assumed to encompass the full range of wavelengths depicted in FIG. 5A, and can extend considerably beyond those bounds. The peaks of each trace represent the wavelengths at which the transmit rings Tx1 and Tx2 absorb light, and consequently the wavelengths of minimum intensity from the transmitter. In alternate embodiments the optical lengths can be in any convenient arrangement as long as appropriate spacing is maintained between ring resonant frequencies.

At the receive side, the optical lengths of resonators Rx[1:4] also increase from left to right in this simple example, and their responses have substantially the same FSRs as the transmit rings. Different lengths can be used in this example to produce resonators for which the wavelength responses have approximately the same FSRs over the optical bandwidth of interest. The FSRs of the receive resonators are offset from those of neighboring resonators by about one fourth the common FSR so that the peaks of the four responses effectively span the optical bandwidth of the incoming light. The peaks of each waveform represent the wavelengths at which the receive rings Rx[1:4] absorb light, and consequently the wavelengths of maximum receive intensity.

In this example the resonant wavelengths of rings Tx1 and Tx2 are precisely aligned with those of resonators Rx1 and Rx3, respectively. Thus, the peaks that indicate their respective resonant wavelengths are aligned. The transmit rings conveys a minimum intensity of light at their peak wavelengths. Thus, even though the receiver resonators are selectively receptive to those wavelengths, there is little available signal and the outputs of resonators Rx1 and Rx3 are minimal. Slight wavelength misalignments can be introduced at the transmit side by altering the carrier density of the transmit rings, thereby modulating their optical lengths, in which case the amplitudes of the signals from receive resonators Rx1 and Rx3 vary dramatically. Frequency modulation at the transmit side of the channel can thus be used to convey information to the receive side.

The spacing between the peaks of the different receive resonators are large relative to the wavelength variations required for modulation. With their peaks misaligned with respect to the transmit rings, receive resonators Rx2 and Rx4 will receive relatively intense signals at their resonant frequencies, and will thus output relatively high intensity signals. When misaligned, the relatively minor wavelength fluctuations due to modulation at the transmitter are no longer sufficient to bring the transmitter peaks into alignment with those of resonators Rx2 and Rx4, so modulation results in little or no discernible intensity modulation at the outputs of resonators Rx2 and Rx4 and the transmitter is essentially out-of-tune with receivers Rx2 and Rx4. Modulating the light using rings Tx1 and Tx2 thus produces a greater difference between the maximum and minimum intensities for resonators Rx1 and Rx3 than for Rx2 and Rx4. As a consequence, and with reference to FIG. 1, reference voltages Vr1 and Vr3 would be higher than Vr2 and Vr4, and signal sense circuitry 165 would cause multiplexer 170 to select signals V1(n) and V3(n) as output signals DaA(n) and DaB(n), respectively. Signals V2(n) and V4(n) are simply ignored. In other embodiments lower reference voltages are indicative of received signals, as will be understood by those of skill in the art.

FIG. 5B illustrates an example in which, due to a change in temperature at the transmitter, the resonant wavelengths of rings Tx1 and Tx2 have drifted toward higher wavelengths by an amount equal to one fourth of their common FSR, or by some integer number of their FSR+FSR/4 (i.e., the drift=FSR(Int+¼)). A similar misalignment may occur due to drift of the resonant wavelengths at the receiver. In this scenario the resonant wavelengths of rings Tx1 and Tx2 are now precisely aligned with those of resonators Rx2 and Rx4, respectively. Modulating the light using rings Tx1 and Tx2 thus produces a greater difference between the maximum and minimum intensities for resonators Rx2 and Rx4 than for Rx1 and Rx3. With reference to FIG. 1, reference voltages Vr2 and Vr4 would be higher than Vr1 and Vr3, and signal sense circuitry 165 would cause multiplexer 170 to select signals V2(n) and V4(n) as output signals DaA(n) and DaB(n), respectively.

FIG. 5C illustrates an example in which the resonant wavelengths of rings Tx1 and Tx2 have drifted toward still higher wavelengths by an amount equal to half their common FSR, or by some integer number of their FSR+FSR/2 (i.e., the drift=FSR(Int+½)). In this scenario the resonant wavelengths of rings Tx1 and Tx2 are precisely aligned with those of resonators Rx3 and Rx1, respectively. Signals DaA and DaB are therefore most evident at resonators Rx3 and Rx1, respectively. This is just the opposite as in the example of FIG. 5B. Sense circuitry 165 is able to distinguish between the scenarios of FIGS. 5A and 5B in part because the channels are uniquely identified during an initialization sequence. In one embodiment, for example, a test signal is conveyed as input DaA while input DaB is idle. Sense circuitry 165 then identifies which of samplers 160 is producing the greatest reference voltage, and is thus in receipt of the test signal. Sense circuitry 165 is thereafter able to distinguish between the two channels, and keeps track of them as they drift between the receive resonators.

One skilled in the art can further appreciate the use of additional receive rings with closer frequency spacing than is used at the transmit/modulation side in order to provide better resolution and tracking of the drift movements associated with the temperature dependence of receive, transmit or relative receive/transmit configurations. Such additional finer-spaced channels of information can be mixed with other channels or their intensities relative to other channels can be used directly as indicators of drift and affect final multiplexer selection or signal mixing.

The resonant wavelengths of resonators Rx[1:4] are spaced so that neighboring bandwidths sufficiently overlap to provide discernible signals from adjacent resonators as a modulated wavelength drifts from one resonator to the next. In one embodiment sense circuitry tracks a measure of local temperature to determine the direction of wavelength drift. This allows the sense circuitry to know whether a handoff to one of the resonators should come from e.g. the next shorter or next longer resonator.

FIG. 5D illustrates an example in which the resonant wavelengths of rings Tx1 and Tx2 have drifted by an amount equal to their common FSR divided by eight, or by some integer number of their FSR+FSR/8 (i.e., the drift=FSR(Int+⅛). In this scenario the resonant wavelengths of rings Tx1 and Tx2 are not precisely aligned to any of the receive resonators. The number and spacing of the receive resonators is such that some of each modulated signal is evident in each resonator. Input signal DaA is evident, albeit is relatively low amplitude, at resonators Rx1 and Rx2, and input signal DaB is likewise evident at resonators Rx3 and Rx4. This example marks the point at which sense circuitry 165 is about to transition between resonator pairs. With reference to FIG. 1, should the amplitudes of signals Vr1 and Vr3 rise above those of Vr2 and Vr4, for example, sense circuitry 165 will cause multiplexer 170 to either stay with or transition to signals V1(n) and V3(n) output signals DaA(n) and DaB(n), respectively.

The FSRs of resonators Rx[1:4] are all nearly equal within the bandwidth of the incoming light, and the increased resonator granularity at the receiver ensures that the peaks of the collective responses cover the entire optical bandwidth of interest. Due to the repetitive nature of the peaks, the number of receive resonators required to span the optical bandwidth is limited to the number of peaks required to reasonably span a single FSR. In the example of FIGS. 5A-5D, a carrier wavelength for a transmitted signal drifting from below 1,525 nanometers to above 1,560 nanometers always encounters a peak from one of the receive resonators, and can thus be sensed. The repetitive and relatively evenly spaced peaks thus allow a small number of receive resonators to cover a relatively broad optical bandwidth. This may be of particular importance for ring resonators fabricated using processes compatible with economical CMOS processes, as silicon ring resonators tend to be very sensitive to thermal drift.

The examples used herein employ optical resonators at the transmit side, but other modulation schemes can be used. In other embodiments, for example, optical signals with relatively narrow spectra can be intensity modulated. These and other options are well known to those of skill in the art.

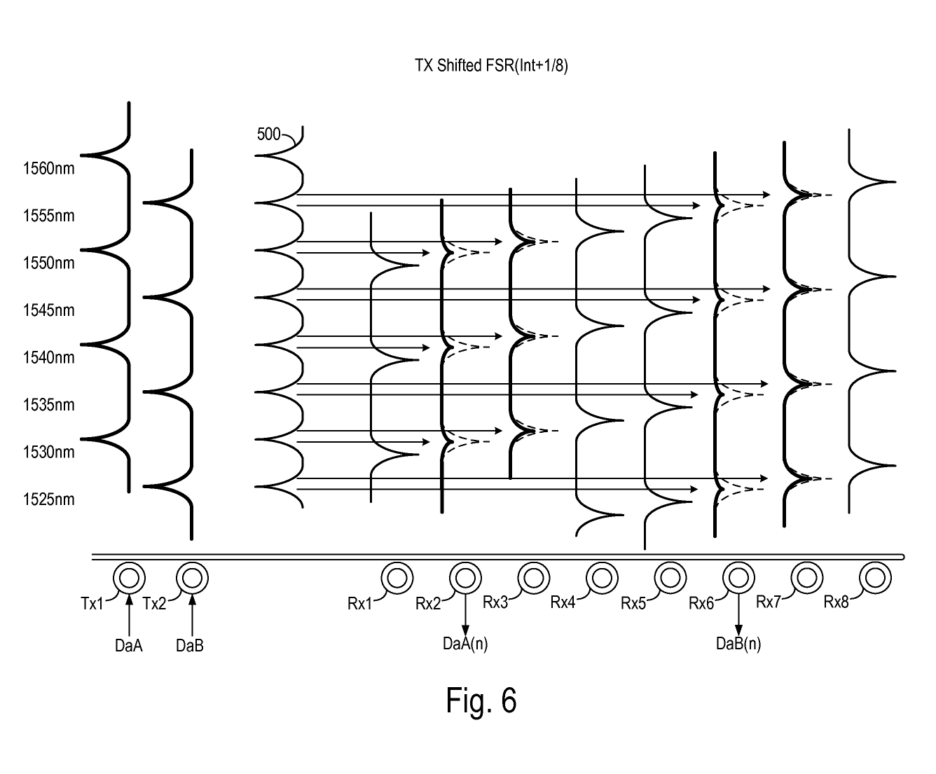

FIG. 6 illustrates an embodiment that includes two transmit photonic rings Tx1 and Tx2 (M=2) and eight receive resonators Rx[1:8] (N=8). The lengths of resonators Rx[1:8] are assumed to increase from left to right so that wavelength shifts at the transmitter that cause their responses to move toward longer wavelengths tend to shift from one resonator pair to the next from left to right, circling back to resonator Rx1 from resonator Rx8. The increased number of receive resonators allows their resonant wavelengths to more completely span one another's FSRs. Stated differently, the peaks in the frequency response of each optical resonator are separated by one FSR, and the peaks of all the N resonators collectively span the entire optical bandwidth with any transmit modulator's output reasonably being able to be captured within the overlapping FSRs of the combined receive system

In this example the resonant wavelengths of rings Tx1 and Tx2 most nearly aligned with those of resonators Rx2 and Rx6, respectively, so output signals DaA and DaB are taken from those resonators. The peaks are partially aligned with resonators Rx3 and Rx7, so those resonators exhibit some amplitude variation as well, albeit to a lesser degree than resonators Rx2 and Rx6. In the illustrated example, and assuming sensor circuitry is tracking signals DaA and DaB, increased amplitude variations at resonator Rx3 would be interpreted as a drift from left to right, from resonator Rx2, rather than from resonator Rx4. As compared with the examples of FIGS. 5A-5D, the increased resonator granularity in this example facilitates wavelength tracking Some embodiments combine signals from multiple resonators to recover one of the M electronic signals.

Making resonators with precise physical lengths, or even precisely different lengths, can be difficult or impractical. Some embodiments may therefore provide more than enough resonators than required to create peaks that overlap without leaving gaps in the relevant optical bandwidth. The individual optical lengths can also be adjusted electronically or by other means to establish and maintain desired spacing between the multiple rings. The number of transmit rings is limited to two in these examples for ease of illustration, but is expected to be greater in practical systems.

An output of a process for designing an integrated circuit, or a portion of an integrated circuit, comprising one or more of the circuits described herein may be a computer-readable medium such as, for example, a magnetic tape or an optical or magnetic disk. The computer-readable medium may be encoded with data structures or other information describing circuitry that may be physically instantiated as an integrated circuit or portion of an integrated circuit. Although various formats may be used for such encoding, these data structures are commonly written in Caltech Intermediate Format (CIF), Calma GDS II Stream Format (GDSII), or Electronic Design Interchange Format (EDIF). Those of skill in the art of IC design can develop such data structures from schematic diagrams of the type detailed above and the corresponding descriptions and encode the data structures on computer readable medium. Those of skill in the art of integrated circuit fabrication can use such encoded data to fabricate integrated circuits comprising one or more of the circuits described herein.

While the present invention has been described in connection with specific embodiments, variations of these embodiments will be obvious to those of ordinary skill in the art. For example, an N:M ring signaling system can be extended to bidirectional optical systems with M rings and light sources on each side. In such a system individual channel allocation can be done separately by direction to avoid interference and can be allocated ahead of time, on power-up, or dynamically as a load-adjustable system. Such bidirectional use of the same medium and of rings for both transmit and receive functions is particularly suited to high-performance CPU-CPU and CPU-memory interfaces which may experience highly asymmetric and variable bandwidth requirements. In other embodiments control mechanisms are used to adjust the resonant frequency of individual rings on either the transmit or receive side. Such controls are used in combination with multiplexer selection or with output mixing of the receive devices to reduce the required range of the thermal or bias controls and result in an overall improvement in power efficiency and/or performance. In some embodiments such thermal or voltage bias controls are used primarily to maintain channel spacing between adjacent communication channels and minimize inter-channel interference. In some embodiments transmit modulations is accomplished with the aid of an Echelle grating.

Moreover, some components are shown directly connected to one another while others are shown connected via intermediate components. In each instance the method of interconnection establishes some desired electrical communication between two or more circuit nodes, or terminals. Such interconnection may often be accomplished using a number of circuit configurations, as will be understood by those of skill in the art. Therefore, the spirit and scope of the appended claims should not be limited to the foregoing description. Only those claims specifically reciting “means for” or “step for” should be construed in the manner required under the sixth paragraph of 35 U.S.C. §112.

1. An optical receiver comprising:
a waveguide to convey light of a bandwidth encompassing a range of wavelengths;
N optical resonators optically coupled to the waveguide, each optical resonator having a respective optical length and resonating at a respective set of wavelengths;
N electro-optical sensors, each optically coupled to a respective one of the optical resonators, to produce N electronic signals; and
an N-to-M conversion circuit electrically coupled to the N electro-optical sensors to convert the N electronic signals into M electronic signals, where M is less than N.

2. The receiver of claim 1, wherein the respective set of wavelengths for each optical resonator are minimally spaced by a respective free spectral range (FSR).

3. The receiver of claim 2, wherein the FSRs for the optical resonators are substantially equal.

4. The receiver of claim 3, wherein the FSRs for the optical resonators overlap.

5. The receiver of claim 1, wherein each optical resonator exhibits a wavelength response with peaks at the respective wavelengths, and wherein the peaks of the optical resonators collectively span the bandwidth.

6. The receiver of claim 1, further comprising a channel sensor coupled to the N-to-M conversion circuit, the channel sensor to relate at least one of the N optical resonators to one of the M electronic signals.

7. The receiver of claim 1, the N-to-M conversion circuit to combine a subset greater than M of the N electronic signals to produce the M electronic signals.

8. An optical communication system comprising:
a waveguide to convey light of a bandwidth encompassing a range of wavelengths;
a transmitter that includes M light modulators optically coupled to the waveguide to modulate the light; and
a receiver that includes:
N optical resonators, where N is greater than M, optically coupled to the waveguide, each optical resonator having a respective optical length and resonating at a respective plurality of the wavelengths; and
N electro-optical sensors, each optically coupled to a respective one of the optical resonators, to produce N electronic signals.

9. The system of claim 8, wherein the receiver further includes an N-to-M conversion circuit coupled to the N electro-optical sensors to convert the N electronic signals into M electronic signals.

10. The system of claim 8, wherein the wavelengths for each optical resonator are minimally spaced by a respective FSR.

11. The system of claim 10, wherein the FSRs for the optical resonators are substantially equal.

12. The system of claim 11, wherein the FSRs for the optical resonators overlap.

13. The system of claim 12, wherein each optical resonator exhibits a frequency response with peaks at the respective plurality of wavelengths, and wherein the peaks of the optical resonators collectively span the bandwidth.

14. The system of claim 8, further comprising an N-to-M conversion circuit to combine a subset greater than M of the N electronic signals to produce M electronic signals.

15. The system of claim 14, further comprising a channel sensor to relate each of the M light modulators to a respective one of the M electronic signals.

16. A method for demodulating an optical signal at a carrier wavelength, the method comprising:
conveying the optical signal past a first optical resonator exhibiting a first resonance at a first wavelength and a second optical resonator exhibiting a second resonance at a second wavelength;
monitoring a first output from the first optical resonator and a second output from the second optical resonator; and
selecting between the first and second optical resonators based on the first and second outputs.

17. The method of claim 16, further comprising recovering the optical signal from a selected one of the first and second optical resonators.

18. The method of claim 16, wherein the optical signal is one of M optical signals and the first and second optical resonators are two of N optical resonators, each optical resonator having a respective optical length and resonating at a respective plurality of the wavelengths.

19. The method of claim 18, wherein the wavelengths for each optical resonator are minimally spaced by a respective free spectral range.

20. The method of claim 19, wherein the free spectral ranges are substantially equal.

21. (canceled)

22. (canceled)
